(19) United States
(12) Patent Application Publication
(10) Pub. No.: US 2026/0031368 A1
(43) Pub. Date: Jan. 29, 2026

(54) BIPOLAR PLATE WITH AN INNER COATING AND AN OUTER COATING

(71) Applicant: Reinz-Dichtungs-GmbH, Neu-Ulm (DE)

(72) Inventors: Johannes KÖBELE, Ulm (DE); Thomas STÖHR, Laupheim (DE); Robert BLERSCH, Mietingen (DE)

(21) Appl. No.: 19/279,964

(22) Filed: Jul. 24, 2025

(30) Foreign Application Priority Data
Jul. 25, 2024 (DE) 20 2024 104 204.2

(51) Int. Cl. H01M 8/0247; H01M 8/0206; H01M 8/0213; H01M 8/0258

(52) U.S. Cl. CPC H01M 8/0247; H01M 8/0206; H01M 8/0213; H01M 8/0258

(57) ABSTRACT

The present disclosure relates to a bipolar plate for an electrochemical system and an electrochemical system comprising a stacked plurality of such bipolar plates as well as a method for the production of such bipolar plates. The electrochemical system may be a fuel cell system, an electrochemical compressor, an electrolyzer, or a redox flow battery. The bipolar plate comprises a first separator plate and a second separator plate connected to each other which delimit an inner space. Each separator plate has an inner side with an inner coating and an outer side with an outer coating. Fluid guide structures are molded into an electrochemically active region of each separator plate by shaping of the respective separator plate. The inner coating extends along the electrochemically active region and has defects at least in some regions. The outer coating extends along the electrochemically active region and has a substantially uniform surface texture.

### CROSS REFERENCE TO RELATED APPLICATION

This application claims priority to German Utility Model Application No. 20 2024 104 204.2, entitled “BIPOLAR PLATE WITH AN INNER COATING AND AN OUTER COATING”, filed Jul. 25, 2024. The entire contents of the above-identified application is hereby incorporated by reference for all purposes.

### TECHNICAL FIELD

The present disclosure relates to a bipolar plate for an electrochemical system and an electrochemical system comprising a stacked plurality of such bipolar plates as well as a method for the production of such bipolar plates. The electrochemical system may in particular be a fuel cell system, an electrochemical compressor, an electrolyzer, or a redox flow battery.

### BACKGROUND AND SUMMARY

Depending on the application, bipolar plates can have different functions. On the one hand, they are used to ensure an electrically conductive connection to an adjoining layer, which may be for example a gas diffusion layer. On the other hand, separator plates are typically used to supply and/or remove reactants and/or reaction products, whereby a fluid guide structure in the form of a channel structure is usually provided for this supply/removal. The bipolar plates can also be used to remove reaction heat, for example by means of a coolant. This is often achieved by the bipolar plate being designed as a two-layer plate and the two layers of the plate defining an inner space through which a coolant flows. The layers are often referred to as separator plates due to their function of separating media.

The reaction conditions during operation of the electrochemical system often have a negative effect on the service life of the bipolar plates. Aggressive reaction conditions (e.g. oxidation of H₂ and the generation of H⁺ and e⁻) can often lead to corrosion of the bipolar plate, particularly on the outer side of a two-layer bipolar plate. On the other hand, there is significantly less corrosion in the inner space on the inner side of the two-layer bipolar plate because the electrochemical reactions take place on the outer side of the bipolar plate.

To counteract corrosion of the bipolar plate, the bipolar plate can be provided with an anti-corrosion coating in the electrochemically active region, for example. To ensure permanent corrosion resistance of the bipolar plate, this coating should be prevented from being damaged during manufacture or transportation of the bipolar plate.

However, the application of such anti-corrosion coatings can be expensive and time-consuming due to the materials used for the coating and/or the additional process steps. When selecting a suitable anti-corrosion layer, the electrical contact resistance of the bipolar plate should also be taken into account, as the bipolar plate should be electrically conductive in the electrochemically active region.

There is therefore a constant need to improve bipolar plates in terms of their corrosion resistance, their electrical contact resistance, their manufacturing costs and/or their service life.

According to one aspect of this document, a bipolar plate is proposed. The bipolar plate comprises a first separator plate and a second separator plate, which are connected to each other and which delimit an inner space of the bipolar plate. Each separator plate has an inner side with an inner coating and an outer side with an outer coating, whereby fluid guide structures are molded into an electrochemically active region of each separator plate by shaping the respective separator plate. The inner coating extends along the electrochemically active region and has defects at least in some regions. The outer coating extends along the electrochemically active region and has a substantially uniform surface texture.

When molding the fluid guide structures, sections of the separator plate surface are typically stretched. Some other sections can be compressed. This stretching and/or compression of the surface of the separator plate has an effect on the coating of the separator plate, if the coating was already present on the substrate of the separator plate before shaping. This is because the coating is typically thinner and less elastic than the substrate of the separator plate and tears more quickly. The stretching and/or compression causes the coating to, in some places, thin out, become damaged or crack. The shaping of the separator plate therefore leads to localized damage to the coating, also referred to below as defects.

Such damage to the coating on the outer sides, that is on the outer surfaces of the metal sheets should be avoided for the reasons mentioned above. The outer coating should therefore be applied to the separator plate after the separator plate has been formed, that is shaped. This sequence of process steps can thus be recognized by the fact that the outer coating is largely intact and has a substantially uniform surface texture, while the inner side(s), that is the inner surface(s) of the metal sheet(s) has defects.

As described above, aggressive reaction conditions prevail, particularly on the outer side of the bipolar plate, which lead to corrosion of the bipolar plate. On the other hand, the inner side of the bipolar plate is shielded from the aggressive electrochemical reactions and only coolant flows through the inner space of the bipolar plate. It is therefore less serious if there are defects in the inner coating on the inner side than if defects are present in the outer coating. This applies in particular when using a suitable substrate, for example stainless steel according to AISI standard 316L.

The fact that the separator plates are provided with the inner coating before shaping can be advantageous, for example, if applying the inner coating to a smooth, non-shaped separator plate is easier in terms of process technology than applying it to a surface of the separator plate that already has fluid guide structures. This can apply, for example, to printing processes such as screen printing, rolling or varnishing the coating material onto the substrate of the separator plate.

In particular, it can be advantageous for a manufacturer of bipolar plates to procure pre-coated strip material for the production of the separator plates from a supplier, because in this case the manufacturer does not need to own/provide additional plant technology and equipment for further coating systems for the inner coating. In addition to the aforementioned application processes, PVD, CVD and electroplating processes can also be used.

It is also possible to use coating materials for the inner coatings that are somewhat less corrosion-inhibiting than the outer coatings (described in more detail below).

The inner coating can have a different surface character in a shaped region of the respective separator plate than in a non-shaped region of the separator plate. The respective inner coating may have defects in the form of cracks, for example, microcracks, scratches and other damage. It is also possible that the inner coating in the shaped region of the separator plate is partially (that is, in some regions) missing. The defects can also be characterized by a reduced or uneven coating thickness, which is caused by the expansion of the separator plate during forming. The shaped region may generally comprise the electrochemically active region, and may sometimes comprise only this electrochemically active region, i.e. not comprise any other regions. Areas of the separator plate/bipolar plate that are not designed to carry fluid can comprise planar regions, which can be referred to as non-shaped regions.

It may be the case that in the region of the defects, i.e. between the intact sections of the inner coating, the substrate of the separator plate forms the surface of the separator plate. That is, in the regions where the inner coating is missing/does not cover the surface of the substrate, i.e. the inner coating has defects, sections of the substrate, i.e. in particular the metallic plate material, can lie on the surface.

It may be provided that the two separator plates are connected to each other by means of at least one materially-bonded connection such as a welded joint. At least one of the outer coatings or both outer coatings can be arranged on the materially-bonded connection, for example a welded joint. The outer coating can therefore be applied to the respective separator plate after the separator plates have been connected. The outer coating is therefore not damaged or burnt through by the welded joint. The at least one welded joint is often provided in flat regions of the two separator plates. Sometimes the at least one welded joint is located outside the electrochemically active region, i.e. outside the flow field and/or inside a non-fluid-guiding region of the bipolar plate. However, it is also possible that, in particular additional, welded joints are located inside the electrochemically active region.

In one embodiment, at least one of the outer coatings or each of the outer coatings is applied opaquely. In other words, the substrate of the separator plate is covered by the outer coating everywhere where the outer coating has been applied. The coating can be described as opaque if the smallest measured layer thickness of the coating is at least 50%, optionally at least 75% of the average layer thickness. Similarly, a coating can be described as opaque if the mass fraction of the coating materials on the surface in any surface increment of the electrochemically active region is higher than the mass fraction of the substrate. In particular, the mass fraction of all coating materials on the surface in any surface increment of the electrochemically active region can be at least 70%, for example at least 75%. Optionally, the mass fractions are determined using SEM-EDX; for the preferred materials and coating thicknesses, which may be from 20 to 500 nm, the measurements are optionally taken at a voltage of 10 kV and with a working distance (WD) of 12 mm. The outer coating can have a uniform layer thickness, over a distance of 10 μm on the outer surface the variation of the layer thickness is a maximum of ±20%, this can apply in any direction or any region, but optionally in continuous web crest or channel bottom regions. The uniformity of the outer coating is also demonstrated by the low fluctuation in the mass fraction of the coating materials, whose mass fraction fluctuates by a maximum of ±20% over the aforementioned distance of 10 μm within the electrochemically active region.

At least one, several or all of the coatings can be applied to the entire surface of the respective side of the separator plates. Applied to the entire surface means that the respective surface or region has been completely covered with the coating. The coating may therefore have been completely applied to the inner side, but may no longer be opaque due to the subsequent shaping.

According to some embodiments, the inner coating and the outer coating differ in terms of their materials. This means that the inner and outer coatings can be selected to suit the operating conditions of the electrochemical system. Alternatively, the inner coating and the outer coating can be made of the same material and thus be identical in terms of material. It is possible that orthogonal projections of the inner coating and the outer coating overlap.

The outer coating can be configured as an anti-corrosion layer and/or configured to reduce the contact resistance of the bipolar plate. Exemplary layers include elements of subgroups 4, 5 and 9 to 11, such as nitrides, carbonitrides, oxynitrides, carbides and carbooxynitrides as well as carbon. The carbon can be formed as a separate layer or as several layers, for example, it can form the top layer of the coating.

The outer coating can comprise or be a PVD coating (PVD=physical vapor deposition). A PVD coating is generally characterized by its stability and durability due to the covalent bonds with the substrate. Depending on the choice of material, a PVD coating is particularly suitable as an anti-corrosion layer or to reduce the contact resistance of the bipolar plate. The outer coating and optionally, the inner coating can comprise or consist of titanium and/or carbon, for example.

The outer coating can have at least one layer, for example two or more layers. In the case of a PVD coating, for example, a first layer can first be applied to the substrate and then a second layer can be applied to the first layer.

The application of PVD coatings can be time-consuming and costly. Time can be saved if the outer coatings of the separator plates are applied to the substrate of the bipolar plate after the separator plates have been joined. In this case, two separator plates do not have to be coated individually, but the bipolar plate can be coated in one step.

The inner coating may be designed to increase the electrical conductivity of the bipolar plate and/or to reduce the contact resistance of the bipolar plate. The contact resistance of an inner coating may be a maximum of 6 mΩ·cm². The following materials, for example, are suitable for the inner coating: Elements of subgroups 4, 5 and 9 to 11, such as nitrides, carbonitrides, oxynitrides, carbides and carbooxynitrides as well as carbon. The carbon can be formed as a separate layer or as several layers, for example, it can form the top layer of the coating.

The fluid guide structures on the inner side may form complementary fluid guide structures on the outer side of the respective separator plate. The respective coatings are generally arranged at least in the region of the fluid guide structures and/or in an electrochemically active region of the respective plate. The fluid guide structures may be shaped into the respective separator plate by deep drawing, embossing or hydroforming.

The following describes the steps of a method for manufacturing an object described above, i.e. a bipolar plate.

Such a method of manufacturing the above-described article may comprise, for example, at least the following steps:
Providing a first separator plate with an inner side, an outer side and an inner coating arranged on the inner side,
Providing a second separator plate with an inner side, an outer side and an inner coating arranged on the inner side,
Shaping of the first separator plate to form fluid guide structures at least in an electrochemically active region of the first separator plate, wherein the inner coating is arranged at least in the region of the fluid guide structures,
Shaping of the second separator plate to form fluid guide structures at least in an electrochemically active region of the second separator plate, wherein the inner coating is arranged at least in the region of the fluid guide structures,
Connecting, optionally materially-bonding, the first separator plate to the second separator plate, and
Applying an outer coating to the outer side of the first separator plate at least in the region of the fluid guide structures and/or an outer coating to the outer side of the second separator plate at least in the region of the fluid guide structures.

The inner coating forms an uneven surface with defects due to the shaping process. The inner coating can form a different surface character in a shaped region of the respective separator plate than in a non-shaped region of the separator plate, as a result of the shaping process. The aforementioned non-shaped region of the respective separator plates does not have to be directly adjacent to the shaped region. Non-shaped regions adjacent to the shaped region can still have a locally altered inner coating due to the expansion of the separator plates during shaping. For example, the non-shaped region is located in a flat edge region of the respective separator plate.

The following methods are suitable for applying the inner coating: PVD, other sputtering processes, CVD, screen printing, spraying, rolling and electroplating processes.

Such a method of manufacturing the above-described article may additionally comprise at least the following step:

It is possible that the first separator plate and the second separator plate are welded together when they are joined.

Such a method of manufacturing the above-described article may additionally comprise at least the following step:

Application of the outer coating by means of PVD, for example, after shaping and/or joining of the separator plates. Alternatively, the outer coating can be applied using other sputtering processes, CVD, printing processes and, in particular, spraying processes.

Such a method of manufacturing the above-described article may additionally comprise at least the following step:

Application of the outer coating to the outer side of the first separator plate and application of the outer coating to the outer side of the second separator plate at the same time or at least in the same method step.

In the same method step can mean that the layers can be applied in parallel or with a time delay in the same tool without other process steps being carried out in between requiring a tool change.

The method is designed in particular for manufacturing the bipolar plate of the type described above. The method can therefore be combined with features of the bipolar plate and vice versa.

Furthermore, an electrochemical system is proposed which comprises a plurality of stacked bipolar plates of the type described above. The electrochemical system can be, for example, a fuel cell system, an electrochemical compressor, an electrolyzer or a redox flow battery.

Examples of embodiments of the electrochemical cell and the electrochemical system are shown in the attached figures and are explained in more detail in the following description.

### BRIEF DESCRIPTION OF THE FIGURES

FIG. 1 schematically shows, in a perspective view, an electrochemical system comprising a plurality of bipolar plates arranged in a stack.

FIG. 2 schematically shows, in a perspective view, two bipolar plates each consisting of two separator plates, of the system according to the prior art, having a membrane electrode assembly (MEA) arranged between the bipolar plates.

FIG. 3 schematically shows a section through a stack of a system of the type shown in FIG. 1 along a line comparable to the sectional line A-A shown in FIG. 2.

FIG. 4 shows a scanning electron microscope (SEM) image of a coated surface that has been shaped after coating.

FIG. 5 shows a scanning electron microscope (SEM) image of a coated surface that was shaped before coating.

FIG. 6 shows a representation of SEM (top) and energy dispersive X-ray spectroscopy (EDX) results (bottom) of a coated surface that has been shaped after coating.

FIG. 7 shows a representation of SEM (top) and energy dispersive X-ray spectroscopy (EDX) results (bottom) of a coated surface that was shaped prior to coating.

FIG. 8 shows a schematic representation of a section through a bipolar plate in the region of a welded joint according to one embodiment.

FIG. 9 shows a flow chart for a method for manufacturing a bipolar plate.

### DETAILED DESCRIPTION

Here and in the following, recurring features in various figures are each labeled with the same or similar reference characters. In some cases, the repeated use of reference characters in the figures that follow has been omitted for the sake of clarity.

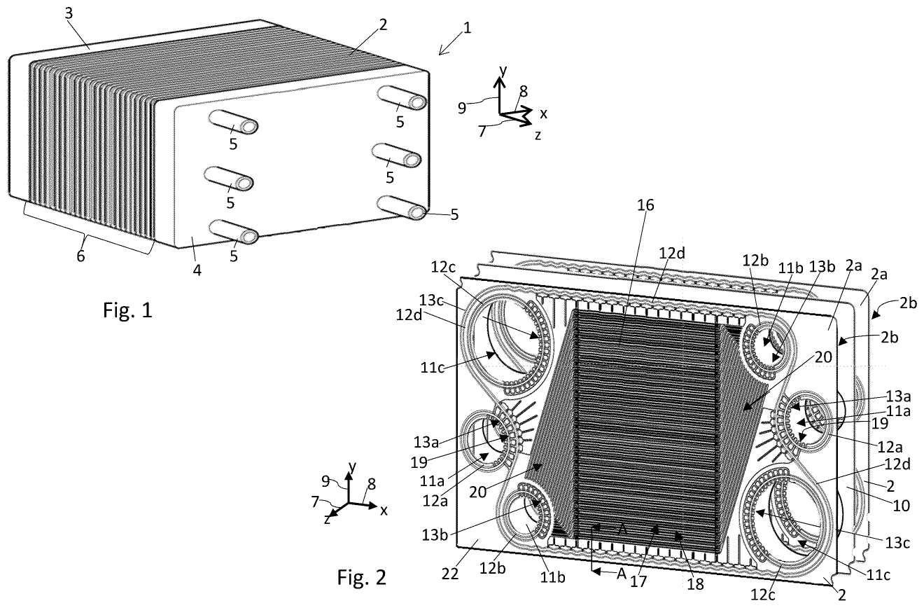

FIG. 1 shows an electrochemical system 1 with a plurality of identical metallic bipolar plates 2, which consist of separator plates 2a, 2b and which, together with membrane electrode assemblies 10 and gas diffusion layers 14, form electrochemical cells, which are arranged in a stack 6 and are stacked along a z-direction 7. The bipolar plates 2 of the stack 6 are clamped between two end plates 3, 4. The z-direction 7 is also called the stacking direction. In this example, system 1 is a fuel cell stack. Two closest separator plates 2a, 2b of two adjacent bipolar plates 2 of the stack delimit an electrochemical cell, which is used, for example, to convert chemical energy into electrical energy. To form the electrochemical cells of the system 1, a membrane electrode assembly (MEA) 10 is arranged between adjacent bipolar plates 2 of the stack. The MEAs typically contain at least one membrane, e.g. an electrolyte membrane, and a frame-shaped membrane reinforcement layer that surrounds the membrane in a frame shape and reinforces it. Furthermore, a gas diffusion layer (GDL) 14 can be arranged on one or both surfaces of the MEA, not shown in FIGS. 1 and 2.

In alternative embodiments, the system 1 can also be configured as an electrolyzer. Separator plates can also be used in such alternative embodiments. The structure of these separator plates can then correspond to the structure of the separator plates 2a, 2b described in more detail here, even if the media fed onto or through the separator plates in an electrolyzer may differ from the media used for a fuel cell system.

Together with an x-axis 8 and a y-axis 9, the z-axis 7 spans a right-handed Cartesian coordinate system. The separator plates 2a, 2b define a plate plane at their contact plane, whereby the plate planes are each aligned parallel to the x-y plane and thus perpendicular to the stacking direction, that is, the z-axis 7. The end plate 4 comprises a plurality of media connections 5, via which media can be supplied to the system 1 and via which media can be discharged from the system 1. These media that can be supplied to and discharged from the system 1 can include, for example, fuels such as molecular hydrogen or methanol, reaction gases such as air or oxygen, reaction products such as water vapor or depleted fuels or coolants such as water and/or glycol. Gases are often supplied by means of fans and/or compressors, while coolant is usually supplied with the aid of at least one pump.

FIG. 2 shows a perspective view of two adjacent bipolar plates 2 of an electrochemical system of the type of system 1 of FIG. 1 as well as a membrane electrode assembly (MEA) 10 known from the prior art arranged between these adjacent bipolar plates 2, the MEA 10 in FIG. 2 being largely concealed by the separator plate 2 that faces the observer. The bipolar plate 2 is formed of two separator plates 2a, 2b that are joined together in a materially-bonded manner, of which only the first separator plate 2a facing towards the viewer is visible in FIG. 2, said first separator plate concealing the second separator plate 2b. The separator plates 2a, 2b may each be manufactured from a metal sheet, for example from a stainless-steel sheet. The separator plates 2a, 2b may for example be welded to one another, for example by laser welded joints. Two closest separator plates 2a, 2b, together with the MEA 10 and any GDLs present (but not shown here), form an electrochemical cell.

The separator plates 2a, 2b have through-openings, which are aligned with each other and form through-openings 11a-c in the bipolar plate 2. When stacking a plurality of plates of the type of the bipolar plate 2, the through-openings 11a-c form conduits that extend through the stack 6 in the stacking direction 7 (see FIG. 1). Typically, each of the conduits formed by the through-openings 11a-c is fluidically connected to one of the media connections 5 in the end plate 4 of the system 1. By way of the conduits formed by the through-openings 11a, it is possible for e.g. coolant to be introduced into the stack or discharged from the stack. By contrast, the conduits formed by the through-openings 11b, 11c may be configured to supply the electrochemical cells of the fuel cell stack 6 of the system 1 with fuel and with reaction gas and to discharge the reaction products from the stack. The media-conducting through-openings 11a-11c are essentially parallel to the plate plane of the individual bipolar plates 2.

In order to seal off the through-openings 11a-c from the interior of the stack 6 and from the external environment, the first separator plates 2a each have sealing arrangements in the form of sealing beads 12a-c, which are each arranged around the through-openings 11a-c and which each fully enclose the through-openings 11a-c. The second separator plates 2b, on the rear side of the bipolar plates 2 that faces away from the observer of FIG. 2, have corresponding scaling beads for sealing off the through-openings 11a-c (not shown).

In an electrochemically active region 18, the first separator plates 2a have, on their front side facing towards the observer of FIG. 2, a flow field 17 with structures for guiding a reaction medium along the front side of the separator plate 2a. These structures are shown in FIG. 2 by a large number of webs and channels 16 running between the webs and delimited by the webs. On the front side of the bipolar plates 2 that faces the observer of FIG. 2, the first separator plates 2a also each have a distribution and collection region 20. Distribution or collection regions 20 each comprise structures that are configured to distribute a medium introduced into the distribution region 20 from a first of the two through-openings 11b over the active region 18, or to collect/direct a medium flowing from the active region 18 to the second of the through-openings 11b. In FIG. 2, the fluid guide structures of both distribution or collection regions 20 are also webs and channels that run between the webs and are delimited by the webs.

The sealing beads 12a-12c have feedthroughs 13a-13c that enable the passage of medium through the sealing beads 12a-12c.

The first separator plates 2a also each have a further sealing arrangement in the form of a perimeter bead 12d, which surrounds the flow field 17 of the active region 18, the distribution and collection regions 20 and the through-openings 11b, 11c and seals these off from the through-opening 11a, i.e. from the coolant circuit, and from the external environment of the system 1. The second separator plates 2b each comprise corresponding perimeter beads. The structures of the active region 18, the distribution structures of the distribution and collection region 20 and the sealing beads 12a-d are each shaped integrally with the separator plates 2a and are molded into the separator plates 2a, e.g. in an embossing or deep-drawing process or via hydroforming. The same applies to the corresponding structures of the second separator plates 2b.

The two through-openings 11b/the conduits through the plate stack of the system 1 that are formed by the through-openings 11b are fluidically connected to one another via passages 13b in the sealing beads 12b, via the distributing structures of the distribution or collection region 20 and via the flow field 17 in the active region 18 of the first separator plates 2a that faces towards the observer of FIG. 2. In an analogous manner, the two through-openings 11c/the conduits formed by the through-openings 11c through the plate stack of the system 1 are in fluid connection with each other via corresponding bead feedthroughs, via corresponding distribution and collection structures and via a corresponding flow field on an outer side of the second separator plates 2b facing away from the observer of FIG. 2. In contrast, the through-openings 11a/the conduits through the plate stack of the system 1 that are formed by the through-openings 11a are fluidically connected to one another via a cavity 19 that is enclosed or surrounded by the separator plates 2a, 2b. This cavity 19 is used to guide a coolant through the bipolar plate 2, in particular to cool the electrochemically active region 18 of the separator plates 2a, 2b.

In the following, the sealing beads 12a, 12b, 12c, 12d are also collectively described as sealing arrangement 12. The sealing arrangement 12 therefore comprises only one, at least one or all of the sealing beads 12a-d. Overall, the sealing arrangement 12 defines the fluid-guiding region 17 of the respective plate, within which the media (cooling fluid, reactants, product media) flow/are guided.

The present disclosure is based, inter alia, on the following considerations. The operating conditions inside the bipolar plate 2, i.e. in the coolant chamber 19, are different to those on the outer side of the bipolar plate 2. Thus, the oxidation of the fuels and the resulting electrochemical potentials can lead to oxidation or corrosion of the outer sides of the bipolar plates 2, while the inner side (coolant side) in the electrochemically active region 18 hardly experiences any corrosion problems.

To produce the bipolar plate 2, the individual separator plates 2a, 2b are shaped to form the channels 16, 16′ and other structures such as scaling beads, e.g. by molding. When shaping the separator plates 2a, 2b to form channels 16, 16′, sections of the separator plate 2a, 2b including the surface are typically stretched or compressed. This has a particular effect on pre-coated sheet metal, as the coating is also affected by the shaping process and may even be damaged. This is particularly problematic if, as is usually the case, the coating is less ductile than the sheet metal substrate. However, due to the reduced corrosion problems, this is acceptable on the inner side of the bipolar plate 2. However, such damage to the coating on the outer side of the bipolar plate 2 should be avoided. Therefore, according to this document, it is proposed not to use pre-coated material on the outer side, but to coat the sheet only after shaping.

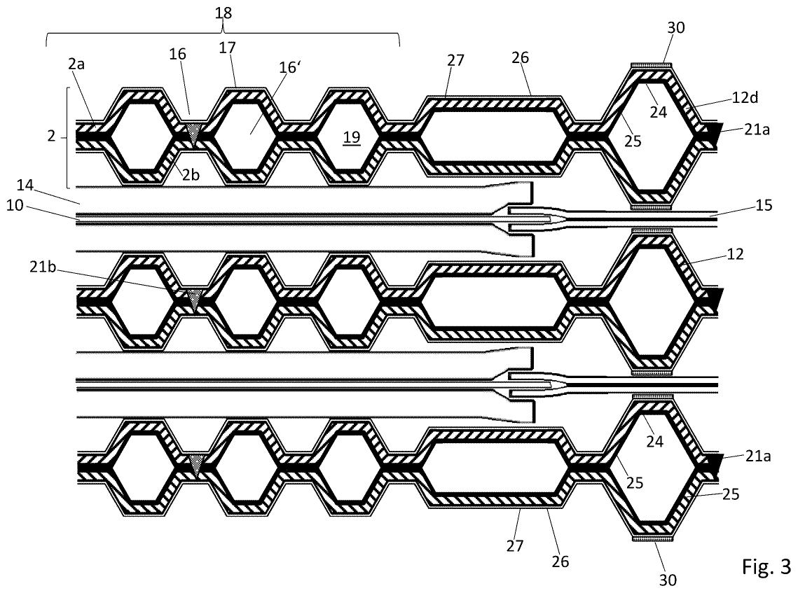

The present disclosure is explained in more detail below with reference to FIGS. 3-8. The features of FIGS. 1 and 2 can be combined with the features of FIGS. 3-8, provided they do not contradict one other.

According to the present document, a bipolar plate 2 is proposed, which has a first separator plate 2a and a second separator plate 2b. As previously discussed with reference to FIG. 2, the separator plates 2a, 2b are connected to each other and delimit an inner space 19 of the bipolar plate 2. Each separator plate 2a, 2b has an inner side 24 with an inner coating 25 and an outer side 26 with an outer coating 27.

Channel-shaped fluid guide structures 16 are shaped into each separator plate 2a, 2b by molding the respective separator plate 2a, 2b. Here, the fluid guide structures 16′ on the inner side 24 usually form complementary shaped fluid guide structures 16 on the outer side 26 of the respective separator plate 2a, 2b. The inner coating 25 is arranged in the region of the fluid guide structures 16′ and typically extends along the electrochemically active region 18. Optionally, the inner coating 25 can extend over the entire inner side 24 and as such be applied over the entire surface of the inner side 24 of the separator plates 2a, 2b. The inner coating 25 was applied to the separator plates 2a, 2b before the separator plates 2a, 2b were shaped. The inner coating 25 can be designed to increase the electrical conductivity of the bipolar plate 2 and/or to reduce the contact resistance of the bipolar plate 2. The contact resistance of the inner coating 25 may be a maximum of 6 mΩ·cm². Due to the fact that pre-coated plates or plates made of fully pre-coated strip material were used to form the fluid guide structures 16, 16′, the inner coating 25 exhibits defects in some regions as a result of the subsequent shaping process. As a result, the inner coating 25 is often no longer completely covering the inner side 24 of the respective separator plate 2a, 2b after shaping.

The outer coating 27 is arranged in the region of the surfaces of the fluid guide structures 16 and may extend at least along the electrochemically active region 18. Optionally, the outer coating 27 can extend over the entire outer side 26 of the respective separator plate 2a, 2b and as such can be applied over the entire outer side 26 of the separator plates 2a, 2b. The outer coating 27 was applied to the substrate of the separator plates 2a, 2b after shaping of the separator plates 2a, 2b, whereby the outer coating 27 has a substantially uniform surface texture. It can therefore be provided that the respective outer coating 27 is applied over the entire surface, covering the entire surface and with an essentially constant layer thickness. The outer coating 27 may, for example, comprise or be a PVD (physical vapor deposition) coating. According to one embodiment, the outer coating 27 is configured as an anti-corrosion layer and/or is configured to reduce the contact resistance of the bipolar plate 2. The outer coating 27 may, for example, comprise or consist of titanium and/or carbon. The outer coating 27 can be present as a single layer or can have at least two layers. For example, titanium can be applied as the first layer on the substrate of the separator plate 2a, 2b. A carbon layer can then be applied to the Ti layer. Alternative material options used as the first layer, that is, the layer closest to the substrate, include, for example, metal nitrides such as ZrN, TiN, CrN or TiAlN or other metal compounds such as TiCN and TiON. The first layer and the second layer can, for example, have layer thicknesses of at least 20 nm, at least 25 nm or at least 50 nm and/or have a maximum of 500 nm, a maximum of 300 nm or a maximum of 200 nm.

In FIG. 3, a further layer is present in sections on the outer coating 27, cf. the polymer sealant 30, which may be applied by means of screen printing or rolling. The polymeric scaling 30 is located outside the electrochemically active region 18 on a bead roof of the bead arrangement 12 and is intended to provide a local micro-seal, while the sealing bead 12 itself is intended to provide a macro-seal. This means that the bipolar plate for micro sealing in the area of the bead arrangement may show another coating than the one described here, it may for instance have a coating for micro sealing which is applied on top of the outer or inner coating 27, 25 and covers it/them at least in these sections.

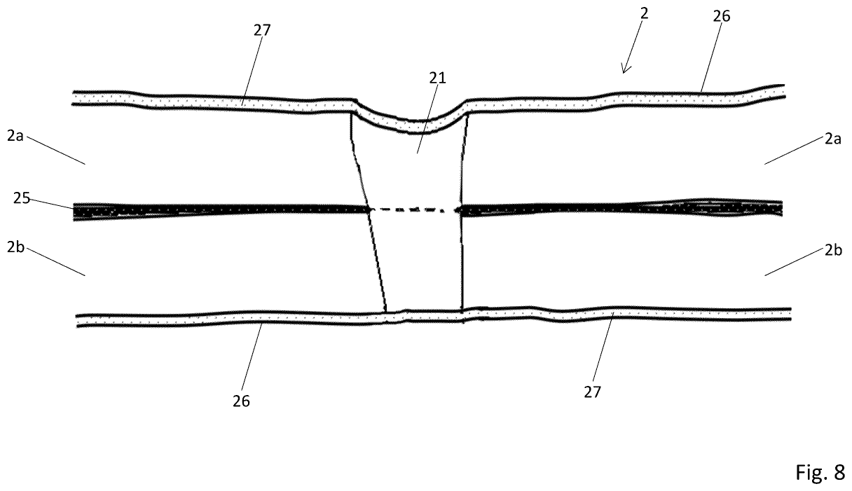

The two separator plates 2a, 2b are connected to each other by means of at least one welded joint 21, whereby at least one of the outer coatings 27 can be arranged on the welded joint 21, see FIG. 8. In this case, the separator plates 2a, 2b are therefore provided with the outer coatings 27 after welding. The at least one welded joint 21 may be provided in a planar region 22 of the separator plates 2a, 2b, such as in a non-fluid-carrying edge region, see region 22 in FIG. 2. A corresponding welded joint 21a, for example, for a tight welding of the separator plates 2a, 2b is given adjacent to the perimeter bead 12d in FIG. 3. In this planar region, the separator plates 2a, 2b are generally in contact with each other, which simplifies the welding of the plates 2a, 2b. Optionally, there may be welding joints 21b in the electrochemically active region, too. These welding joints 21b are optionally realized as short welding stiches and may be provided in addition to the welded joints 21a. FIG. 3 shows welded joints 21a, 21b which are covered by the outer coating 27.

Due to the different requirements and conditions on the inner side and outer side of the bipolar plate 2, the inner coating 25 and the outer coating 27 may differ in terms of their materials and layer thicknesses. Alternatively, the inner coating 25 and outer coating 27 can also be formed from the same material and/or can have the same layer thicknesses.

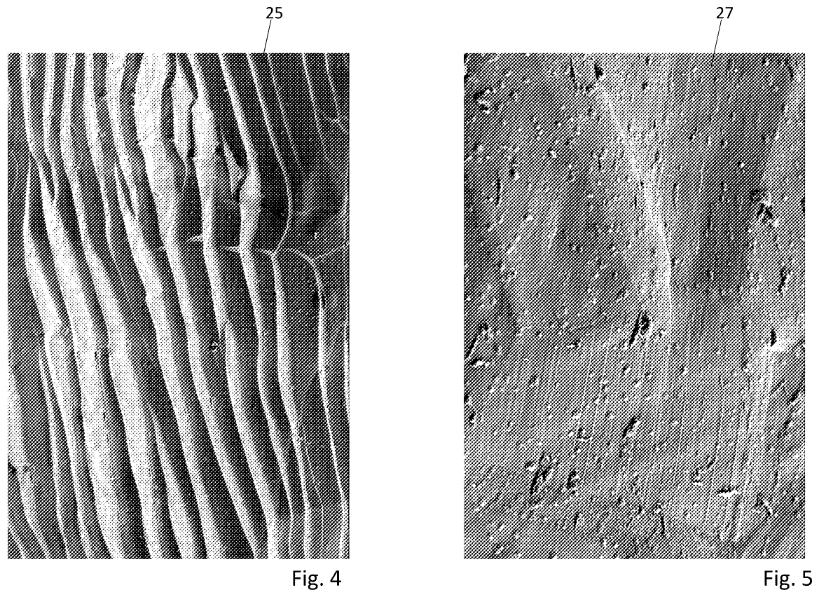

FIGS. 4-7 show a comparison of coatings 25 applied before molding and coatings 27 applied after molding. For better comparability, both coatings 25, 27 of FIGS. 4-7 comprise the same materials, namely titanium and carbon.

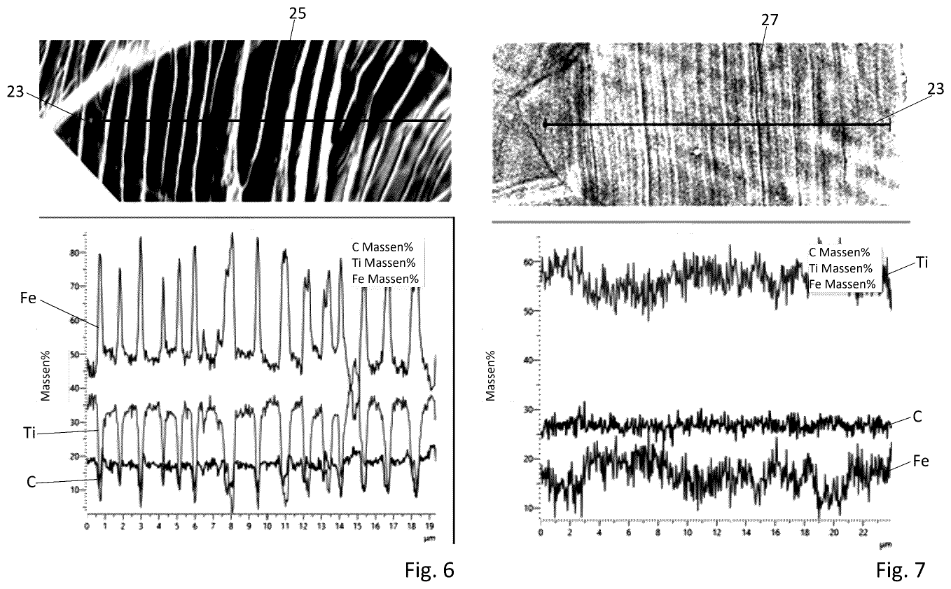

In FIGS. 4 and 6, microcracks are clearly visible in the SEM images, which were caused by the subsequent shaping of the separator plates 2a, 2b in the coating 25. The coating 25 is stretched, thinned, torn or damaged by the shaping process, resulting in the microcracks mentioned above.

In the SEM images shown in the upper part of FIGS. 6 and 7, lines 23 are shown along which energy dispersive X-ray spectroscopy (EDX) measurements were made. The SEM images were taken at a voltage of 10 kV and with a working distance (WD) of 12 mm. The microcracks are manifested in the EDX images by fluctuating proportions of Fe, Ti and C. In the case of a crack, the proportion of the coating (C, Ti) decreases significantly, while the proportion of the plate material (Fe) increases to a similar extent. This leads to the conclusion that the cracks go all the way to the plate material and are not just in the coating.

On the other hand, it can be seen in FIGS. 5 and 7 that the coating 27, which was applied to the sheet material after shaping, does not have these microcracks and has a significantly smoother, more uniform surface structure. In FIG. 7 below, it is clearly visible that both Ti and C layers have a constant layer thickness, which indicates that both layers are intact.

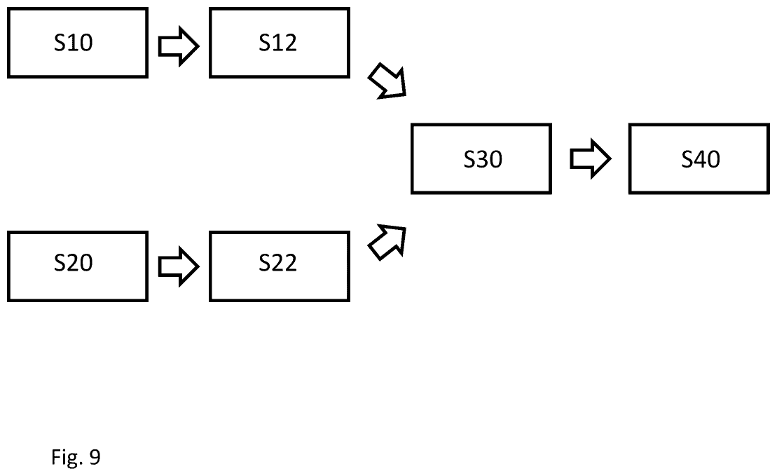

A method for manufacturing the bipolar plate 2 is described below, see also FIG. 9. The method comprises the following steps S10, S20, S12, S22, S30 and S40:
S10 Providing a first separator plate 2a with an inner side 24, an outer side 26 and an inner coating 25 arranged on the inner side 24.
S12 Shaping of the first separator plate 2a to form fluid guide structures 16, 16′ in the electrochemically active region 18, wherein the inner coating 25 is arranged in the region of the fluid guide structures 16′.

In this case, the inner coating 25 in a shaped region of the electrochemically active region 18 of the first separator plate 2a forms a different surface character than in a non-shaped region 22 of the first separator plate 2a, as a result of the shaping.
S20 Providing a second separator plate 2b with an inner side 24, an outer side 26 and an inner coating 25 arranged on the inner side 24.
S22 Shaping of the second separator plate 2b to form fluid guide structures 16, 16′ in the electrochemically active region 18, wherein the inner coating 25 is arranged in the region of the fluid guide structures 16′.

In this case, the inner coating 25 forms a different surface character in a shaped region of the electrochemically active region 18 of the second separator plate 2b than in a non-shaped region 22 of the second separator plate 2b, as a result of the shaping.
S30 Connecting, optionally materially-bonding, the first separator plate 2a to the second separator plate 2b.

When joining, the first separator plate 2a and the second separator plate 2b can be welded together, for example by means of a welded joint 21. The inner coating is often destroyed and removed in the region of the welded joint 21.
S40 Applying an outer coating 27 to the outer side 26 of the first separator plate 2a in the region of the fluid guide structures 16 and an outer coating 27 to the outer side 26 of the second separator plate 2b in the region of the fluid guide structures 16.

The outer coating 27 is applied, for example, by means of PVD, for example after shaping and/or joining the separator plates 2a, 2b. If the welded joint 21 is located outside the electrochemically active region 18, localized damage to the outer coating 27 outside the electrochemically active region 18 increases the risk of corrosion to an acceptable extent. In this case, steps S30 and S40 can be interchanged in their sequence. According to an exemplary embodiment, the outer coating 27 is applied to the outer side 26 of the first separator plate 2a and the outer coating 27 is applied to the outer side 26 of the second separator plate 2b simultaneously, whereby the same coating thickness or different coating thicknesses of the same coating materials are possible on both outer sides.

They can also be applied one after the other if, for example, different outer coatings 27 are required on the anode and cathode sides, e.g. in terms of their composition. In some embodiments, the bipolar plate 2 can remain in the same mold, whereby the application of the different outer layers 27 can be carried out directly one after the other in the same method step.

In a subsequent process step, a further coating can be applied to the bead roof of the bead arrangement 12, in particular in sections, see the polymeric sealant 30 of FIG. 3.

The method is particularly suitable for manufacturing the bipolar plate 2 described above. Features of the method and the bipolar plate 2 can thus be combined with each other.

1. A bipolar plate, comprising a first separator plate and a second separator plate, which are connected to each other and delimit an inner space of the bipolar plate,
wherein each separator plate has an inner side with an inner coating and an outer side with an outer coating,
wherein fluid guide structures are molded into an electrochemically active region of each separator plate by shaping of the respective separator plate,
wherein the inner coating extends along the electrochemically active region and has defects at least in some regions, and
wherein the outer coating extends along the electrochemically active region and has a substantially uniform surface texture.

2. The bipolar plate according to claim 1, wherein the two separator plates are connected to each other by means of at least one welded joint, wherein at least one of the outer coatings is arranged on the welded joint.

3. The bipolar plate according to claim 2, wherein the at least one welded joint is provided in planar regions of the two separator plates.

4. The bipolar plate according to claim 1, wherein in the region of the defects of the inner coating a substrate of the separator plate forms a surface of the separator plate.

5. The bipolar plate according to claim 1, wherein the inner coating and the outer coating differ with respect to their materials.

6. The bipolar plate according to claim 1, wherein the respective outer coating is applied opaquely.

7. The bipolar plate according to claim 1, wherein at least one, several or all of the coatings are applied over an entire surface of the respective side of the separator plates.

8. The bipolar plate according to claim 1, wherein the outer coating comprises or is a PVD coating.

9. The bipolar plate according to claim 1, wherein the outer coating is configured as an anti-corrosion layer and/or is configured to reduce a contact resistance of the bipolar plate.

10. The bipolar plate according to claim 1, wherein the outer coating comprises or consists of titanium and/or carbon.

11. The bipolar plate according to claim 1, wherein the inner coating is configured to increase an electrical conductivity of the bipolar plate or to reduce a contact resistance of the bipolar plate, and wherein the contact resistance of the inner coating is at most 6 mΩ·cm².

12. The bipolar plate according to claim 1, wherein the fluid guide structures on the inner side form complementarily shaped fluid guide structures on the outer side of the respective separator plate.

13. An electrochemical system comprising a plurality of stacked bipolar plates according to claim 1.

14. A method of manufacturing a bipolar plate comprising at least the following steps:
providing a first separator plate with an inner side, an outer side and an inner coating arranged on the inner side,
providing a second separator plate with an inner side, an outer side and an inner coating arranged on the inner side,
shaping of the first separator plate to form fluid guide structures at least in an electrochemically active region of the first separator plate, wherein the inner coating is arranged at least in the region of the fluid guide structures,
shaping of the second separator plate to form fluid guide structures at least in an electrochemically active region of the second separator plate, wherein the inner coating is arranged at least in the region of the fluid guide structures,
connecting the first separator plate to the second separator plate, and
applying an outer coating to the outer side of the first separator plate at least in the region of the fluid guide structures and/or an outer coating to the outer side of the second separator plate at least in the region of the fluid guide structures.

15. The method of manufacturing the bipolar plate according to claim 14, further comprising the following step:
applying the inner coating by means of PVD, other sputtering processes, CVD, screen printing, spraying, rolling or electroplating processes.

16. The method of manufacturing the bipolar plate according to claim 14, further comprising the following step:
laser welding of the first separator plate and the second separator plate.

17. The method of manufacturing the bipolar plate according to claim 14, further comprising the following step:
after shaping and/or joining of the separator plates, applying the outer coating by means of PVD, other sputtering processes, CVD, printing processes or spraying processes.

18. The method of manufacturing the bipolar plate according to claim 14, further comprising the following step:
applying the outer coating to the outer side of the first separator plate and applying the outer coating to the outer side of the second separator plate at the same time or at least in the same method step.

19. The bipolar plate according to claim 10, wherein the inner coating comprises or consists of titanium and/or carbon.

20. The method of manufacturing the bipolar plate according to claim 14, wherein connecting the first separator plate to the second separator plate comprises materially bonding the first separator plate to the second separator plate.
